(19) United States
(12) Patent Application Publication
(10) Pub. No.: US 2025/0131263 A1
(43) Pub. Date: Apr. 24, 2025

(54) MODEL TRAINING APPARATUS, MODEL TRAINING METHOD, AND COMPUTER READABLE MEDIUM

(71) Applicant: NEC Corporation, Minato-ku, Tokyo (JP)

(72) Inventor: Darshit VAGHANI, Tokyo (JP)

(73) Assignee: NEC Corporation, Minato-ku, Tokyo (JP)

(21) Appl. No.: 18/692,907

(22) PCT Filed: Oct. 7, 2021
(86) PCT No.: PCT/JP2021/037108

§ 371 Date: Mar. 18, 2024

(51) Int. Cl. G06N 3/08; G06N 3/0464

(52) U.S. Cl. CPC G06N 3/08; G06N 3/0464

(57) ABSTRACT

In one aspect, a model training apparatus includes at least one memory storing instructions; and at least one processor configured to execute the instructions to: calculate, for objects in a dataset used in the past to train a Convolutional Neural Network (CNN) model, the number of Feature Pyramid Network (FPN) blocks in the CNN model required to detect the object, estimate a parameter value of the number of FPN blocks in the CNN model based on the calculated number of FPN blocks for the objects; and train the CNN model by using the estimated parameter value.

### TECHNICAL FIELD

The present disclosure relates to a model training apparatus, a model training method, and a non-transitory computer readable medium.

### BACKGROUND ART

In the era of machine learning, Convolutional Neural Network (CNN) models are one of the most prominent solutions for the vision analysis tasks. The capability to achieve high accuracy on the large public dataset is the key reason for success of CNN model.

As examples of the related art, Patent Literature 1 (PTL 1) discloses a neural network optimization method for finding an optimum solution of a neural network, and PTL 2 discloses an arithmetic device using a neural network to improve the recognition accuracy in Deep Neural Network (DNN).

### CITATION LIST

### Patent Literature

PTL 1: JP 2021-105950 A
PTL 2: JP 2020-123270 A

### SUMMARY OF INVENTION

### Technical Problem

A Feature Pyramid Network (FPN) block is a feature extractor block responsible for extracting features of objects of various scales and complexity. Stacking several numbers of the FPN block is beneficial to obtain high accuracy. However, in the real time application, stacking fewer number of the FPN blocks is beneficial to obtain high speed. Thereby, there exist a tradeoff problem.

An object of the present disclosure is to provide a model training apparatus, a model training method, and a non-transitory computer readable medium capable of solving the trade-off between accuracy and execution speed of a CNN model.

### Solution to Problem

According to a first aspect of the disclosure, there is a model training apparatus that includes: an estimation means for calculating, for objects in a dataset used in the past to train a Convolutional Neural Network (CNN) model, the number of Feature Pyramid Network (FPN) blocks in the CNN model required to detect the object, and estimating a parameter value of the number of FPN blocks in the CNN model based on the calculated number of FPN blocks for the objects; and a CNN model training means for training the CNN model by using the estimated parameter value.

According to a second aspect of the disclosure, there is a model training method that includes: calculating, for objects in a dataset used in the past to train a Convolutional Neural Network (CNN) model, the number of Feature Pyramid Network (FPN) blocks in the CNN model required to detect the object, estimating a parameter value of the number of FPN blocks in the CNN model based on the calculated number of FPN blocks for the objects; and training the CNN model by using the estimated parameter value.

According to a third aspect of the disclosure, there is provided a non-transitory computer readable medium storing a program for causing a computer to execute: calculating, for objects in a dataset used in the past to train a Convolutional Neural Network (CNN) model, the number of Feature Pyramid Network (FPN) blocks in the CNN model required to detect the object, estimating a parameter value of the number of FPN blocks in the CNN model based on the calculated number of FPN blocks for the objects; and training the CNN model by using the estimated parameter value.

### Advantageous Effects of Invention

According to the present disclosure, it is possible to provide a model training apparatus, a model training method, and a non-transitory computer readable medium capable of solving the trade-off between accuracy and execution speed of a CNN model.

### BRIEF DESCRIPTION OF DRAWINGS

FIG. 1 is an example of a block diagram of a model training apparatus according to a first example embodiment.

FIG. 2 is a flowchart illustrating an example of a method of the model training apparatus according to the first example embodiment.

FIG. 3 is an example of a block diagram of a CNN model training system according to a second example embodiment.

FIG. 4 is an example of a block diagram of a CNN model according to the second example embodiment.

FIG. 5 is an example of a FPN block according to the second example embodiment.

FIG. 6 is an example of a block diagram of a Design Space Reducer (DSR) unit according to the second example embodiment.

FIG. 7A is an example of a block diagram of the CNN model with a FPN_1 invalid according to the second example embodiment.

FIG. 7B is an example of a block diagram of the CNN model with a FPN_n invalid according to the second example embodiment.

FIG. 8 is an example of a survey table according to the second example embodiment.

FIG. 9 is an example of a cardinality table according to the second example embodiment.

FIG. 10 is a flowchart illustrating an example of total processes of the CNN model training system according to the second example embodiment.

FIG. 11A is a flowchart illustrating an example of processes of a survey table generator unit according to the second example embodiment.

FIG. 11B is a flowchart illustrating an example of processes of a survey table generator unit according to the second example embodiment.

FIG. 12 is a flowchart illustrating an example of processes of an Optimal Candidate Estimation (OCE) unit according to the second example embodiment.

FIG. 13 is an example of a block diagram of an information processing apparatus according to the embodiments.

### DESCRIPTION OF EMBODIMENTS

### Outline of Related Art

Prior to explaining embodiments according to this present disclosure, an outline of related art will be explained.

Designing a high accuracy CNN model for the given dataset requires both expertise and large of amount of time. A particular CNN model tends to have several configurable parameters and several candidates for each configurable parameter; thus, an extremely large design space is required in this case. However, it is computationally very expensive to exhaustively search in such large design space.

Multi-Level Feature Pyramid Network (MLFPN) block is one of the most important blocks of the CNN model. The MLFPN block is formed by stacking multiple levels of Feature pyramid network (FPN) block. However, as explained above, there is the trade-off between accuracy and execution speed of a CNN model.

Also, the configurable parameters can have any non-negative integer value, so several candidates in the design space need to be explored in order to optimize the tradeoff. The number of the FPN blocks to be stacked is one of the crucial configurable parameters of the MLFPN block (and the CNN model). Thus, exploring large design space for the number of the FPN blocks to be stacked with the tradeoff of accuracy and execution speed for the give dataset can be called as an optimization problem.

The naive solution is exhaustively enumerating all the candidates in design space; however, it requires large computation time. Another solution is re-enforcement-based optimization, where initially few candidates are tried and then based on the knowledge acquired from the trail, and next candidate is selected for the trail. However, time required for even exploring few candidates becomes also large.

In view of this related art, one of the objects of the present disclosure is to shorten time to search space for the number of FPN block parameter. One specific solution is to employ a Design Space Reducer (DSR) block for performing survey of FPN blocks requirement by individual object in dataset, and based on the survey, an estimating the number of the FPN block parameter is done.

### First Example Embodiment

First, a model training apparatus 100 according to a first example embodiment of the present disclosure is explained with reference to FIG. 1.

Referring to FIG. 1, the model training apparatus 100 includes an estimation unit 101 and a Convolutional Neural Network (CNN) model training unit 102. The model training apparatus 100 includes, for example, one or a plurality of computers or machines having an information processing apparatus. As an example, at least one of components in the model training apparatus 100 can be installed in a computer as a combination of one or a plurality of memories and one or a plurality of processors.

The estimation unit 101 calculates, for objects in a dataset used in the past to train a CNN model, the number of FPN blocks in the CNN model required to detect the object. Further, the estimation unit 101 estimates a parameter value of the number of FPN blocks in the CNN model based on the calculated number of FPN blocks for the objects.

The dataset may include images and labels. The images include the objects to be analyzed by the CNN model, and the labels indicate ground truth information. In another words, the labels are the prediction that the trained CNN model is intended to produce as output.

The plurality of objects to be targeted when the estimation unit 101 calculates the number of FPN blocks may be all or part of the objects of the dataset.

The FPN blocks can be stacked in, but not limited to, MLFPN structure, Single Shot Multibox Detector (SSD)-style feature pyramid structure, or FPN-style feature pyramid structure. An example of structure of the CNN model including the MLFPN block will be described in a second example embodiment.

The CNN model training unit 102 trains the CNN model by using the estimated parameter value.

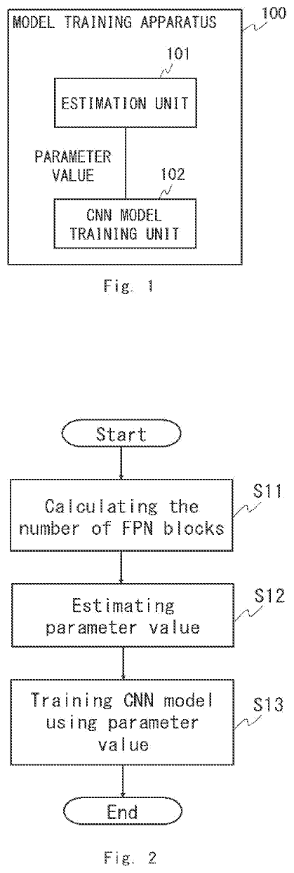

Next, referring to a flowchart in FIG. 2, an example of the operation of the present example embodiment will be described.

First, the estimation unit 101 calculates, for objects in a dataset used in the past to train a Convolutional Neural Network (CNN) model, the number of Feature Pyramid Network (FPN) blocks in the CNN model required to detect the object (step S11 in FIG. 2). Next, the estimation unit 101 estimates a parameter value of the number of FPN blocks in the CNN model based on the calculated number of FPN blocks for the objects (step S12 in FIG. 2). Finally, the CNN model training unit 102 trains the CNN model by using the estimated parameter value (step S13 in FIG. 2).

As the estimation unit 101 estimates the parameter value based on the number of FPN blocks required to detect the object, the CNN model training unit 102 can train the CNN model to make the number of FPN blocks minimum necessary. Therefore, it is possible to provide a model training apparatus and method capable of solving the trade-off between accuracy and execution speed of the CNN model.

### Second Example Embodiment

Next, a second example embodiment of this disclosure will be described below referring to the accompanying drawings. This second example embodiment shows one of the specific examples of the first example embodiment, however, specific examples of the first example embodiment are not limited to this.

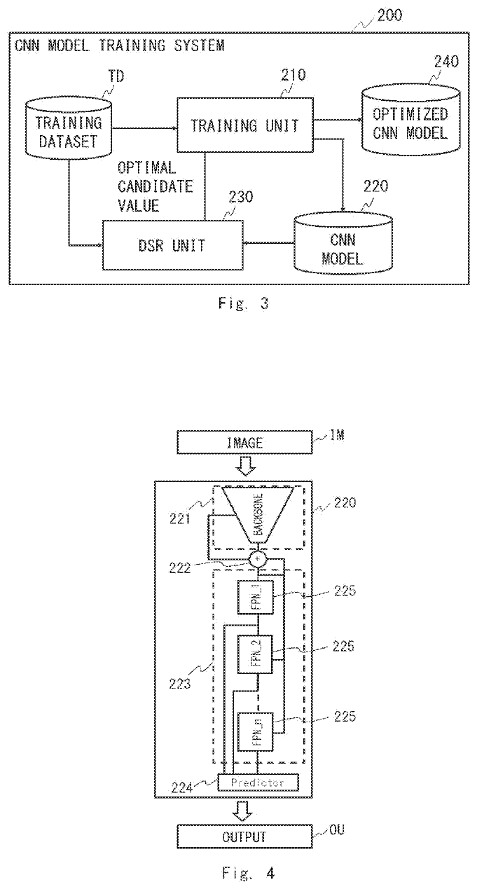

FIG. 3 shows a CNN model training system (hereinafter referred to as the model training system) according to a second example embodiment. As shown in FIG. 3, the model training system 200 includes a CNN model training unit 210 (hereinafter referred to as a model training unit), a trained CNN model 220 (hereinafter referred to as a CNN model), a Design Space Reducer (DSR) unit 230, an optimized CNN model 240 and so forth. For example, the CNN model training system 200 also may comprise memory storing configurations, conditions and threshold values used for processing explained later. Also, the model training system 200 can take a training dataset TD as input and output the CNN model 220 and the optimized CNN model 240.

The model training system 200 can be realized as a system installed in an information processing apparatus. Also, the model training system 200 may include other units for computation. In this example embodiment, the model training system 200 can be applied to the image recognition, however, the application is not limited to this.

The training dataset TD includes images along with label(s) of each image. The explanation of the images and the labels is already explained in the first example embodiment.

The model training unit 210 takes the training dataset TD as input, builds the original CNN model based on the training dataset TD and a pre-defined configuration, executes training of the original CNN model and outputs the result of the training, namely the CNN model 220. The CNN model 220 is used as an input of the DSR unit 230.

Further, after this first training, the model training unit 210 takes the training dataset TD and an optimal candidate value (the number of FPN blocks of the CNN model) as input and set the optimal candidate value as the defined configuration, instead of the pre-defined configuration of the number of FPN block value. The optimal candidate value is a nonnegative integer. In this way, the model training unit 210 builds a new CNN model with the new optimal candidate value and then trains it by using the training dataset TD.

At this procedure, the model training unit 210 may set the initial weight of the new CNN model to the one of the CNN model 220. After that, the model training unit 210 may fine-tunes the weight of the new CNN model by the training with using the training dataset TD.

Consequently, the model training unit 210 outputs the optimized CNN model 240, which has relatively high performance in terms of speed as compared to the CNN model 220 with minimum loss in accuracy. The details of how to generate the optimal candidate value information will be described later.

In FIG. 4, an example of a block diagram of the CNN model 220 is illustrated. The CNN model 220 comprises several vital blocks, specifically backbone block(s) 221, a direct sum block 222, a Multi-Level Feature Pyramid Network (MLFPN) block 223 and a predictor block 224 as shown in FIG. 4. The CNN model 220 takes an Image IM of the training dataset TD as input, processes it and outputs an output OU based on the Image IM.

The architecture of each block in the CNN model 220 is designed with the aim to achieve high accuracy for the given dataset. Also, for real time application, the architecture in the CNN model 220 is designed with the additional aim to achieve desired execution speed.

The backbone block(s) 221 function as backbone convolutional architectures and the direct sum block 222 integrates data input from the backbone block(s) 221. The MLFPN block 223 processes data input from the direct sum block 222 and outputs processed data to the Predictor block 224. The predictor block 224 generates a prediction result of detection of the Image IM based on the processed data and outputs the prediction as the output OU.

The MLFPN block 223 is one of the key components in the CNN model 220. As shown in FIG. 4, the MLFPN block 223 is formed by stacking multiple levels of FPN blocks 225 and hence, it is known as a “Multi-Level Feature Pyramid Network block”. In FIG. 4, there are n FPN blocks; FPN_1, FPN_2 . . . , FPN_n.

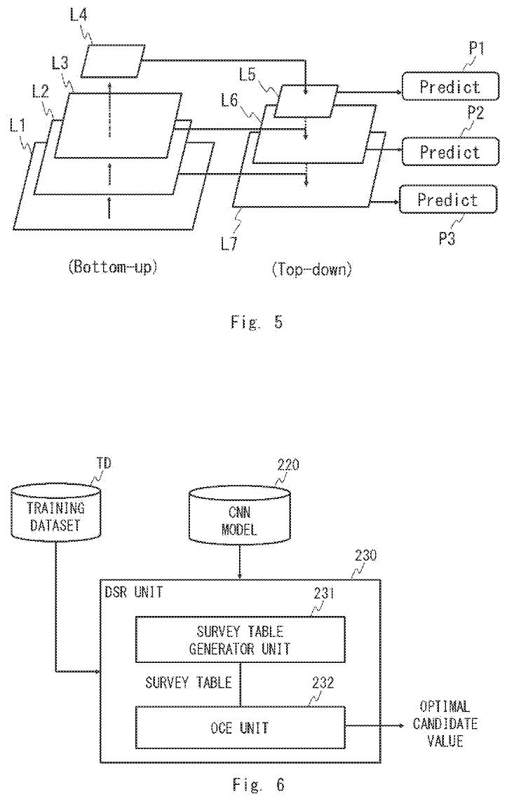

The FPN blocks are feature extractor blocks that are responsible for extracting features of objects of various scales and complexity. A sample example of the FPN block 225 but not limited to is as shown in FIG. 5. FIG. 5 shows the FPN block's architecture including Layers L1, L2, L3, . . . , L4, L5, . . . , L6 and L7. Each of the Layers L1 to L4 at bottom-up steps generates different scale of feature map and each of the Layers L5 to L7 at top-down steps outputs a Prediction based on the feature map from the corresponding Layer at the bottom-up steps. For example, the Layer L5 outputs the Prediction P1 using the feature map from the Layer L4, the Layer L6 outputs the Prediction P2 using the feature map from the Layer L3 and the Layer L7 outputs the Prediction P3 using the feature map from the Layer L2. An architecture of one FPN block 225 can be optimized by experts and then such optimized FPN blocks are stacked to form the MLFPN block 223.

Stacking a number of the FPN blocks 225 is beneficial to obtain high accuracy. However, increasing the levels of the FPN block in the MLFPN block 223 results in large computational complexity of the CNN model and thereby increasing the execution time of the CNN model. The large execution time is inadmissible in the real time applications. Also, stacking one or few levels of the FPN blocks in the CNN model to enjoy less computational complexity and smaller execution time (high speed) may result in low accuracy. Hence, there exist the trade-off problem and the number of the FPN blocks in the MLFPN block 223 is an important parameter of the CNN model and will be referred to as a FPN count value in this example embodiment. Determining optimal value of the FPN count value with considering the tradeoff between accuracy and computational complexity or execution time for the given real time application and dataset is an optimization problem. This second example embodiment can solve this problem.

The DSR unit 230 takes the training dataset TD and CNN model 220 as input and performs analysis of the CNN model 220 to estimate the optimal candidate value (the number of FPN blocks of the CNN model) and output it. As described above, the model training unit 210 outputs the optimized CNN model 240 based on the optimal candidate value.

FIG. 6 shows the details of the DSR unit 230. As shown in FIG. 6, the DSR unit 230 includes a survey table generator unit 231 and an Optimal Candidate Estimation (OCE) unit 232. The details of both units will be explained.

The survey table generator unit 231 takes the training dataset TD and CNN model 220 as input and generates a survey table as output. First, the survey table generator unit 231 performs, by each object in the training dataset TD, survey of the number of FPN blocks in the CNN model 220 required to detect the object.

Specifically, at the survey procedure, when the survey table generator unit 231 input each object in the training dataset TD to the CNN model 220, the survey table generator unit 231 sets weight of any one particular FPN block 225 in the MLFPN block 223 as zero. In another words, the survey table generator unit 231 disables the one particular FPN block 225.

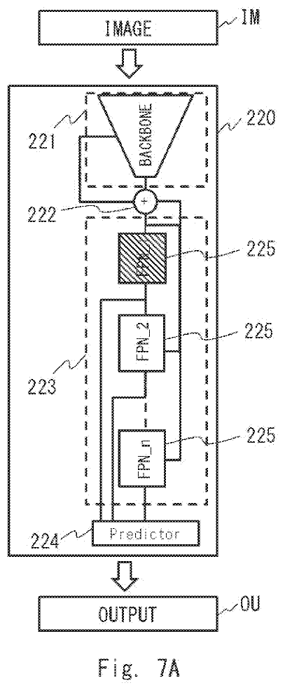

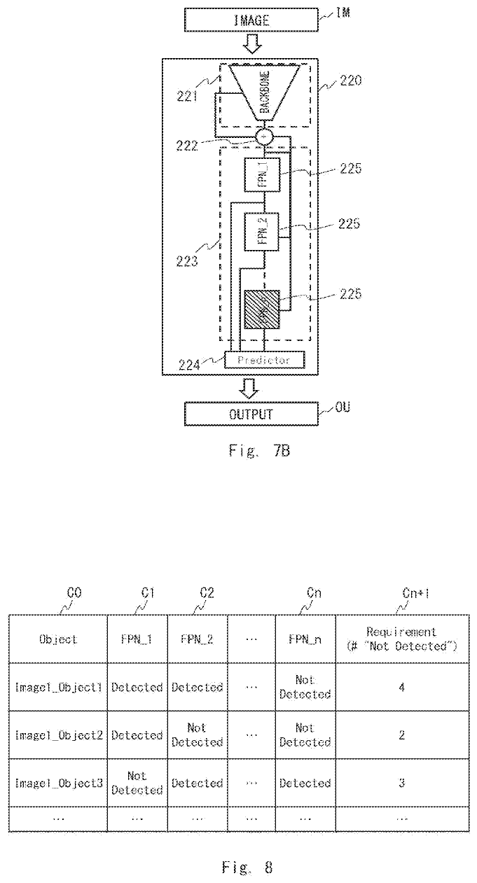

FIG. 7A shows an example of the situation described above: in FIG. 7A, the survey table generator unit 231 sets the weight of the FPN_1 as zero, thus the FPN_1 is masked. In FIG. 7A, the FPN_1 is invalid, while the FPN_2, . . . , FPN_n are valid for processing image detection using the training dataset TD. In this state, the survey table generator unit 231 enumerates all the images in the trained dataset TD and inputs all the images to the CNN model 220.

By masking the FPN_1 (particular FPN block), some of the object in the image might get detected and others might not. The survey table generator unit 231 can determine whether or not each object of the images can be detected, and this information is logged in the form of a survey table as “Detected” or “Not Detected”.

The Survey table generator unit 231 sequentially performs the same determination as that of the FPN_1 with respect to other FPNs (FPN_2, . . . , FPN_n). In another words, in one step of the sequence, the survey table generator unit 231 makes any one particular FPN block invalid for processing image detection, inputs all the images to the CNN model 220 and determine whether or not each object of the images can be detected. FIG. 7B shows an example of the last step of the sequence: in FIG. 7B, the survey table generator unit 231 sets the weight of the FPN_n as zero, thus the FPN_n is masked. This survey method can be called as “Weight Zeroing based-survey”, and this is how the survey table generator unit 231 infers all the images in the trained dataset TD in sequence.

FIG. 8 shows an example of the survey table. In FIG. 8, a column C0 indicates a list of all the objects in all the images, a column C1 indicates a list of the detection result of each object when FPN_1 is invalid, a column C2 indicates a list of the detection result of each object when FPN_2 is invalid, and a column Cn indicates a list of the detection result of each object when FPN_n is invalid. The results of detection of each object from FPN_3 to FPN_n−1 are also included in the survey table as columns C3 to Cn−1, but not shown in FIG. 8.

After the survey table generator unit 231 logs the information of the columns C1 to Cn and checks all the FPN blocks are covered, the survey table generator unit 231 counts the number of the detection results of the FPN blocks in each object that cannot be detected.

For example, regarding an Image1_Object1, the survey table generator unit 231 refers to the results for all FPN blocks in the same row and counts the number determined to be “Not Detected”. Here, since the determined number is 4, the survey table generator unit 231 determines a requirement number to be 4. This requirement number means the number of FPN blocks in the CNN model 220 required to detect the Image1_Object1. In the same way as for Image1_Object1, the survey table generator unit 231 determines a requirement number of the Image1_Object2 to be 2, a requirement number of the Image1_Object3 to be 3, and so on.

The “Detected” in FIG. 8 basically means that a corresponding FPN block is not important to detect corresponding object. Because, even though the corresponding FPN block is masked, the corresponding object gets still detected, the corresponding FPN block is not required to detect the object. However, the “Not Detected” in FIG. 8 means that a corresponding FPN block is required to detect corresponding object, because the masking of the corresponding FPN block leads to non-detection of the object. For this reason, the count in each row represents the number of important FPN blocks for the respective object. In the example of FIG. 8, the number of important FPN blocks for the Image1_Object1 is 4, the number of important FPN blocks for the Image1_Object2 is 2, and the number of important FPN blocks for the Image1_Object3 is 3. As it is like taking requirement survey of the number of FPN blocks for each object in the training dataset TD, the table formed in such a way is referred as the survey table.

In this way, for each row in the survey table, the survey table generator unit 231 counts the number of times “Not Detected” entries in the same respective row and logs the count value (requirement number) in a Requirement column Cn+1 respectively, as shown in FIG. 8. After generating the survey table completely, the survey table generator unit 231 output the survey table.

The OCE unit 232 takes the survey table as input, performs analysis of the survey table and estimates the optimal candidate value for the number of the FPN block, which is used for generating the optimized CNN model 240.

First, the OCE unit 232 lists down all the unique entries (represented values) in the Requirement column Cn+1 of the survey table in the ascending order. Each entry in the Requirement column Cn+1 is logged in the form of a new table (hereinafter referred to as a cardinality table) and can be referred as a candidate value. Then, the OCE unit 232 calculates an occurrence rate (percentage) of each candidate value based on the data of the candidate values and logs it in the table. In another words, it calculates a distribution of the occurrence rate. After that, it calculates a cardinality of each candidate value and logs it in the table. The cardinality (probability) of each candidate value is cumulative addition of the occurrence rate of the equal to and less than respective candidate value.

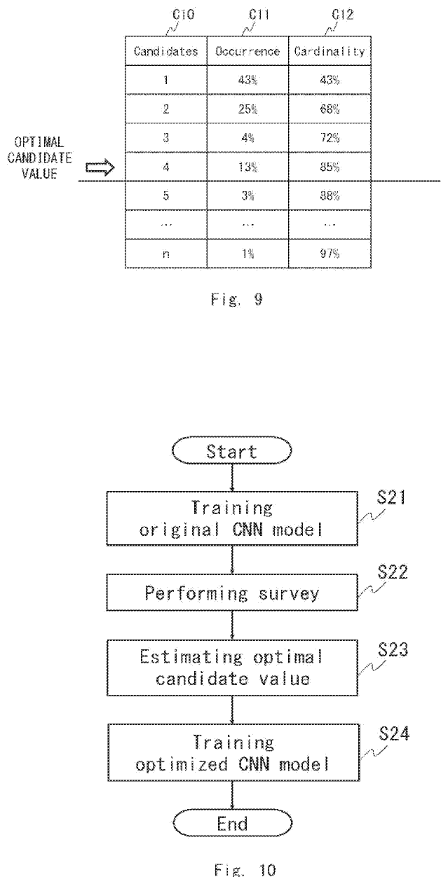

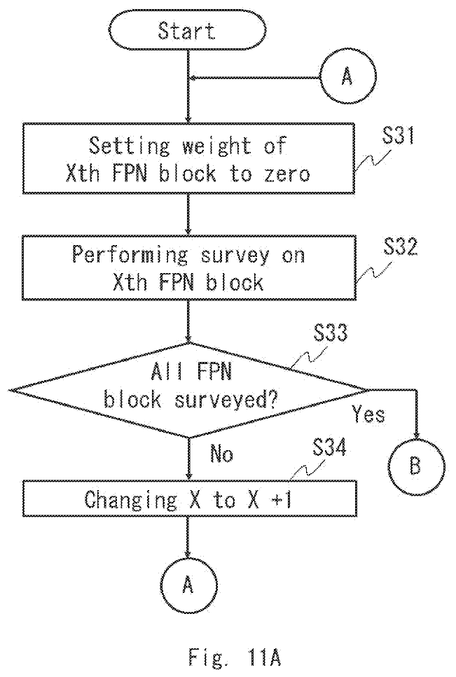

FIG. 9 shows an example of the cardinality table. In FIG. 9, a candidate column C10 indicates the candidate values (unique entries) listed in the ascending order, an occurrence column C11 indicates the occurrence rate (percentage) of each candidate value, and a cardinality column C12 indicates the cardinality of each candidate value. The OCE unit 232 generates the cardinality table through the log procedure.

Each entry (value) of the cardinality column C12 represents the probability of detecting the objects where the candidate value corresponding to each entry (That is, the candidate value listed on the same line as each entry) is the number of FPN blocks required to detect the objects. For example, FIG. 9 shows that the objects can be detected at a rate of 43% when the number of FPN blocks in the CNN model 220 is one, and that the objects can be detected at a rate of 25% higher when the number of FPN blocks is two than when the number of FPN blocks is one. Further, the objects can be detected at a rate of 4% higher when the number of FPN blocks is three than when the number of FPN blocks is two, and the objects can be detected at a rate of 13% higher when the number of FPN blocks is four than when the number of FPN blocks is three. Also, the objects can be detected at a rate of 3% higher when the number of FPN blocks is five than when the number of FPN blocks is four, and the objects can be detected at a rate of 1% higher when the number of FPN blocks is n than when the number of FPN blocks is n−1.

Based on the specific data, the OCE unit 232 calculates the cardinality of each candidate value as follows: the OCE unit 232 calculates the cardinality of the candidate value “1” as the same number of the cardinality of the candidate value “1”, namely 43%. Next, the OCE unit 232 calculates the cardinality of the candidate value “2” as the cumulative addition of the cardinality of the candidate values “1” and “2”, namely 68% (43%+25%). Then, the OCE unit 232 calculates the cardinality of the candidate value “3” as the cumulative addition of the cardinality of the candidate values “1”, “2” and “3”, namely 72% (43%+25%+4%). Further, it calculates the cardinality of the candidate value “4” as the cumulative addition of the cardinality of the candidate values “1” to “4”, namely 85% (43%+25%+4%+13%), and calculates the cardinality of the candidate value “5” as the cumulative addition of the cardinality of the candidate values “1” to “5”, namely 88% (43%+25%+4%+13%+3%).

After calculating the cardinality of all the candidate values, the OCE unit 232 selects one candidate value according to the pre-defined condition: the cardinality value of the candidate value to be selected is less than the pre-defined threshold value and the closest to the pre-defined threshold value. The pre-defined threshold value can be set based on experience on experimental results. Then, the OCE unit 232 outputs the one candidate value as the optimal candidate value (parameter value) for the number of FPN block in the CNN model 220.

In the example of FIG. 9, the pre-defined threshold value is 86% and the cardinality of the candidate value “4” satisfies the above-mentioned condition, thus the OCE unit 232 selects “4” as the optimal candidate value.

After these procedures, the model training unit 210 sets the optimal candidate value input from the OCE unit 232 as the defined configuration and generates the optimized CNN model 240 based on the optimal candidate value. Consequently, the optimized CNN model 240 has the same number of FPN blocks to be stacked in the MLFPN block as indicated by the optimal candidate value. As the optimal candidate value ensures not only that the accuracy of object detection is close to the pre-defined value and that a certain degree of the accuracy is ensured, but also that the number of blocks in the optimized CNN model 240 is minimized. Therefore, the optimized CNN model 240 has relatively high performance in terms of speed as compared to the CNN model 220 with minimum loss in accuracy.

Next, referring to the flowchart in FIG. 10, an example of the total processes of the CNN model training system 200 will be described. The details of each procedure are already described.

First, the model training unit 210 builds the original CNN model based on the training dataset TD and a pre-defined configuration and trains the original CNN model to output the CNN model 220 (step S21 in FIG. 10). Second, the DSR unit 230 performs the survey in the survey table generator unit 231 (step S22 in FIG. 10), and estimates the optimal candidate value in the OCE unit 232 (step S23 in FIG. 10). Finally, the model training unit 210 builds a new CNN model with the new optimal candidate value and then trains the optimized CNN model 240 (step S24 in FIG. 10).

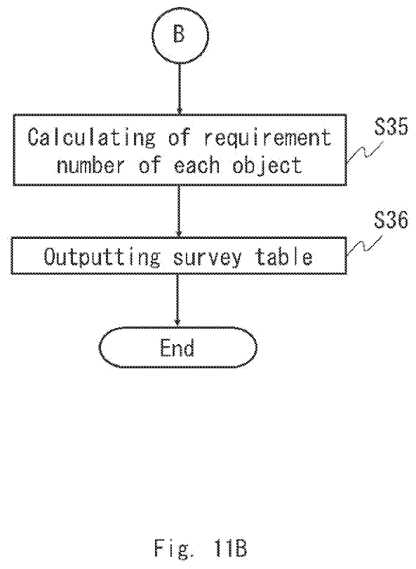

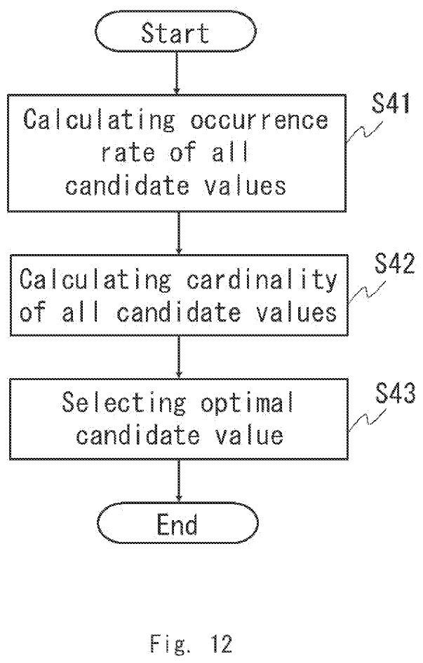

Furthermore, referring to the flowchart in FIGS. 11A and 11B, an example of the processes of the survey table generator unit 231 will be described. In other words, the detail of the process of step S12 will be shown below.

First, the survey table generator unit 231 sets weight of Xth (“X” is any natural number between 1 and n) FPN block in the CNN model 220 as zero (step S31 in FIG. 11A). Then, the survey table generator unit 231 inputs each object in the training dataset TD to the CNN model 220 and surveys whether or not each object of the images can be accurately detected. In short, the survey table generator unit 231 surveys on the Xth FPN block, and it logs this information on the survey table (step S32 in FIG. 11A).

After that, the survey table generator unit 231 checks whether all the FPN blocks are surveyed (covered) or not (step S33 in FIG. 11A). If not (No at Step S33), the survey table generator unit 231 changes X to X+1 (step S34 in FIG. 11A) and repeats the procedures in steps S31 to S33. In another word, the survey table generator unit 231 surveys on the X+1th FPN block and logs this information on the survey table. This iteration ends if all the FPN blocks are surveyed (Yes at Step S33).

If all the FPN blocks are surveyed, in another words, the information of the column C1 to Cn is already surveyed, the survey table generator unit 231 calculates the requirement number of each object in the training dataset TD (step S35 in FIG. 11B). Finally, the survey table generator unit 231 logs the information of the requirement number on the survey table and outputs it (step S36 in FIG. 11B).

Then, referring to the flowchart in FIG. 12, an example of the total processes of the OCE unit 232 will be described. The details of each procedure are already described.

First, the OCE unit 232 organized the information of the candidate values and calculates the occurrence rate of all the candidate values based on the data of the candidate values (step S41 in FIG. 12). Then, it calculates a cardinality of all the candidate values based on the occurrence rate (step S42 in FIG. 12). After that, the OCE unit 232 selects one optimal candidate value according to the pre-defined condition (step S43 in FIG. 12).

As explained above, one of the problems of the related art is the optimization problem. In this example embodiment, the DSR unit 230 calculates, for each object in the training dataset TD, the number of FPN blocks in the CNN model 220 required to detect the object, and estimates the optimal candidate value (parameter value) of the number of FPN blocks in the CNN model 220 based on the calculated number of FPN blocks for each object. Then, the CNN model training unit 210 trains the optimized CNN 240 model by using the optimal candidate value. For the same reason as described in the first example embodiment, it can reduce design space of the number of FPN block parameter value and the optimization problem can be solved.

Further, the survey table generator unit 231 in the DSR unit 230 may determine whether each object is detected by the CNN model 220 by inputting the training dataset TD to the CNN model 220 in a state in which one of the FPN blocks is invalidated, and calculate the number of FPN blocks for each object by executing the determination individually for all the FPN blocks. This method can simplify the calculation.

Further, the OCE unit 232 in the DSR unit 230 may calculate the distribution of the occurrence rate of the number of FPN blocks for the objects to estimate the optimal candidate value. Specifically, the OCE unit 232 may calculate the probability that each object is detected if the number of FPN blocks is less than or equal to the optimal candidate value based on the distribution to estimate the parameter value. This method enables to make accurate calculations that produce the effects described above and get the optimal candidate value in shorter time.

Further, the FPN blocks in the CNN model 220 may constitute the MLFPN block in the CNN model, and the CNN model training unit may adjust the MLFPN block in the optimized CNN model 240 as the optimal candidate value indicates. Thus, this method is effective to a CNN model including a MLFPN block.

It should be noted that in the description of this disclosure, elements represented by the singular forms “a”, “an” and “the” may be not only single elements but also multiple elements, unless the context explicitly stated otherwise.

It should be noted that the present disclosure is not limited to the above-described embodiment, and may be modified as appropriate without departing from the spirit of the invention. For example, the object for the computation is not limited to images.

In the second example embodiment, all objects in the training dataset TD are subject to the calculation of the DSR unit 230, but not all objects (especially important objects) in the training dataset TD may be subject to the calculation of the DSR unit 230.

The order in which the survey table generator unit 231 masks the FPN blocks is not limited to the method described in the second example embodiment.

In the second example embodiment, the OCE unit 232 may adopt another pre-defined condition: the cardinality value of the candidate value to be selected is more than the pre-defined threshold value and the closest to the pre-defined threshold value. Alternatively, the pre-defined condition may be as follows: the cardinality value of the candidate value to be selected is the closest to the pre-defined threshold value. The pre-defined threshold value can be set based on experience on experimental results.

As yet another example, the OCE unit 232 may calculate the distribution of the occurrence rate of the candidate values and estimate the optimal candidate value based on the distribution. For example, it may select the optimal candidate value closest to a value with a certain deviation (the pre-defined threshold value) from the mean value of the distribution. Note that the optimal candidate value may be less or more than the value with the certain deviation from the mean value and the closest to the value with the certain deviation from the mean value.

### (Hardware Configuration)

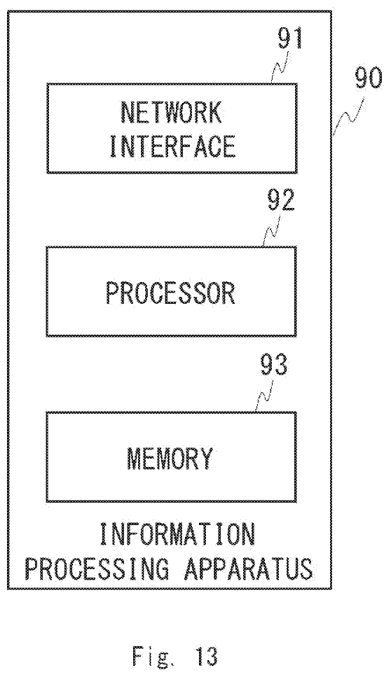

Next, a configuration example of the information processing apparatus explained in the above-described plurality of embodiments is explained hereinafter with reference to FIG. 13.

FIG. 13 is a block diagram showing a configuration example of the information processing apparatus. As shown in FIG. 13, the information processing apparatus 90 includes a network interface 91, a processor 92 and a memory 93.

The network interface 91 is used for communication with other network node apparatuses forming a communication system. For example, the network interface 91 may receive the training dataset TD.

The processor 92 performs processes explained with reference to the drawings in the above-described embodiments by loading software (a computer program) from the memory 93 and executing the loaded software. The processor 92 may be, for example, a microprocessor, an MPU (Micro Processing Unit), or a CPU (Central Processing Unit). The processor 92 may include a plurality of processors. In this case, each of the processors executes one or a plurality of programs including a group of instructions to cause a computer to perform an algorithm explained above with reference to the drawings.

The memory 93 may be formed by a volatile memory or a nonvolatile memory, however, the memory 93 may be formed by a combination of a volatile memory and a nonvolatile memory. The memory 93 may include a storage disposed apart from the processor 92. In this case, the processor 92 may access the memory 93 through an I/O interface (not shown).

In the example shown in FIG. 13, the memory 93 is used to store a group of software modules. The processor 92 can perform processes explained in the above-described embodiments by reading the group of software modules from the memory 93 and executing the read software modules. Also, the memory 93 may store the pre-defined threshold values explained above.

As explained above, each of the configurations in the above-described embodiments may be constituted by the combination of hardware and software (a computer program). However, it may be constituted by one hardware or software, or may be constituted by a plurality of hardware or software.

The program includes instructions (or software codes) that, when loaded into a computer, cause the computer to perform one or more of the functions described in the embodiments. The program may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray disc ((R): Registered trademark) or other optical disk storage, magnetic cassettes, magnetic tape, magnetic disk storage or other magnetic storage devices. The program may be transmitted on a transitory computer readable medium or a communication medium. By way of example, and not limitation, transitory computer readable media or communication media can include electrical, optical, acoustical, or other form of propagated signals.

Note that the present disclosure is not limited to the above-described embodiments and can be modified as appropriate without departing from the spirit and scope of the present disclosure.

### REFERENCE SIGNS LIST

100 Model training apparatus
101 Estimation unit
102 Convolutional Neural Network (CNN) model training unit
200 CNN model training system
210 Convolutional Neural Network (CNN) model training unit
220 Trained CNN model
221 Backbone block
222 Direct sum block
223 Multi-Level Feature Pyramid Network (MLFPN) block
224 Predictor block
225 FPN blocks
230 Design Space Reducer (DSR) unit
231 Survey table generator unit
232 Optimal Candidate Estimation (OCE) unit
240 Optimized CNN model

What is claimed is:

1. A model training apparatus comprising:
at least one memory storing instructions; and
at least one processor configured to execute the instructions to:
calculate, for objects in a dataset used in the past to train a Convolutional Neural Network (CNN) model, the number of Feature Pyramid Network (FPN) blocks in the CNN model required to detect the object;
estimate a parameter value of the number of FPN blocks in the CNN model based on the calculated number of FPN blocks for the objects; and
train the CNN model by using the estimated parameter value.

2. The model training apparatus according to claim 1, wherein the at least one processor is further configured to:
determine whether the objects are detected by the CNN model by inputting the dataset to the CNN model in a state in which one of the FPN blocks is invalidated; and
calculate the number of FPN blocks for the objects by executing the determination individually for all the FPN blocks.

3. The model training apparatus according to claim 1, wherein the at least one processor is further configured to:
calculate a distribution of an occurrence rate of the number of FPN blocks for the objects to estimate the parameter value.

4. The model training apparatus according to claim 3, wherein the at least one processor is further configured to:
calculate a probability that the objects are detected if the number of FPN blocks is less than or equal to the parameter value based on the distribution to estimate the parameter value.

5. The model training apparatus according to claim 1,
wherein the FPN blocks in the CNN model constitute a Multi-Level Feature Pyramid Network (MLFPN) block in the CNN model; and the at least one processor is further configured to:
adjust the MLFPN block in the CNN model as the estimated parameter value indicates.

6. A model training method comprising:
calculating, for objects in a dataset used in the past to train a Convolutional Neural Network (CNN) model, the number of Feature Pyramid Network (FPN) blocks in the CNN model required to detect the object,
estimating a parameter value of the number of FPN blocks in the CNN model based on the calculated number of FPN blocks for the objects; and
training the CNN model by using the estimated parameter value.

7. A non-transitory computer readable medium storing a program for causing a computer to execute:
calculating, for objects in a dataset used in the past to train a Convolutional Neural Network (CNN) model, the number of Feature Pyramid Network (FPN) blocks in the CNN model required to detect the object,
estimating a parameter value of the number of FPN blocks in the CNN model based on the calculated number of FPN blocks for the objects; and
training the CNN model by using the estimated parameter value.
